(19) United States
(12) Patent Application Publication
(10) Pub. No.: US 2008/0119093 A1
(43) Pub. Date: May 22, 2008

(54) Press-Fit Pin For Electrical Contacts Made From Wire Material

(76) Inventors: Martin Bleicher, Fichtenau (DE); Christoph Goeppel, Bechhofen (DE); Peter Goesele, Roehlingen (DE); Erich Koehnert, Diebach (DE); Karl Lechner, Stoedtlen (DE); Anton Stern, Tannhausen (DE); Kurt Vaas, Stoedtlen (DE)

Correspondence Address: BARLEY SNYDER, LLC, 1000 WESTLAKES DRIVE, SUITE 275, BERWYN, PA, 19312, US

(21) Appl. No.: 11/943,186

(22) Filed: Nov. 20, 2007

(30) Foreign Application Priority Data
Nov. 21, 2006 (DE) 102006055086.2

(51) Int. Cl. H01R 4/10

(52) U.S. Cl. 439/877

(57) ABSTRACT

The invention relates to a press-fit pin (1) made from wire material for electrical contacts, in particular plug-in connectors. When using press-fit pins (1) made from wire material the problem of the tips (23) of the press-fit pins (1) being damaged by the press-fit tool has previously occurred. To be able to support a tool on press-fit pins (1) made from wire material without the tips (23) being damaged the press-fit pin (1) made from wire material is provided according to the invention with a shoulder element (3).

### FIELD OF THE INVENTION

The invention relates to a press-fit pin made from wire material for electrical contacts, and for use particularly in plug-in connectors.

### BACKGROUND

To produce solder-free electrical connections it is known to use press-fit pins made from wire material. Press-fit pins are pressed into printed circuit boards or plastic housings with the aid of tools and are used as part of the plug-in connector.

The press-fit tools exert high forces on the pin, for which purpose they have to be supported at their pin tips. In the process the problem of the pin tips being damaged often occurs.

### SUMMARY

An object underlying the invention, among others, is consequently to provide a press-fit pin made from wire material which can be pressed-in without it being damaged.

This object and other objects are achieved according to the invention of a press-fit pin which comprises at least one shoulder element.

### BRIEF DESCRIPTION OF THE DRAWINGS

The invention will be described in more detail by way of example hereinafter using advantageous embodiments and with reference to the drawings. The described embodiments are only possible configurations in which the individual features may however, as described above, be implemented independently of each other or be omitted. In the drawings:

FIG. 1 is a perspective view of a press-fit pin constructed according to the invention with a compressed location,

FIG. 2 is a partial perspective view of a press-fit pin constructed according to the invention with an impression,

FIG. 3 is a perspective view of a plurality of split press-fit pins constructed according to the invention which are framed by a carrier member,

FIG. 4 is a perspective view of a press-fit pin constructed according to the invention with laterally provided noses,

FIG. 5 is a perspective view of a plurality of bent press-fit pins which are framed by a carrier member,

FIG. 6 is a perspective view of a press-fit pin constructed according to the invention and bent in an S-shape,

FIG. 7 is a perspective view of a press-fit pin framed according to the invention by a ring,

FIG. 8 is a perspective view of a plurality of press-fit pins notched according to the invention and framed by a carrier member,

FIG. 9 is a perspective view of a plurality of press-fit pins that, according to the invention, penetrate a flat body,

FIG. 10 is a perspective view of two press-fit pins surrounded according to the invention by two flat bodies,

FIG. 11 is a perspective view of a plurality of press-fit pins welded according to the invention to a carrier strip,

FIG. 12 is a perspective view of a press-fit pin provided according to the invention with welded-on shoulders, and

FIG. 13 is a perspective view of press-fit pin shot through according to the invention by a pin.

### DETAILED DESCRIPTION OF THE EMBODIMENTS

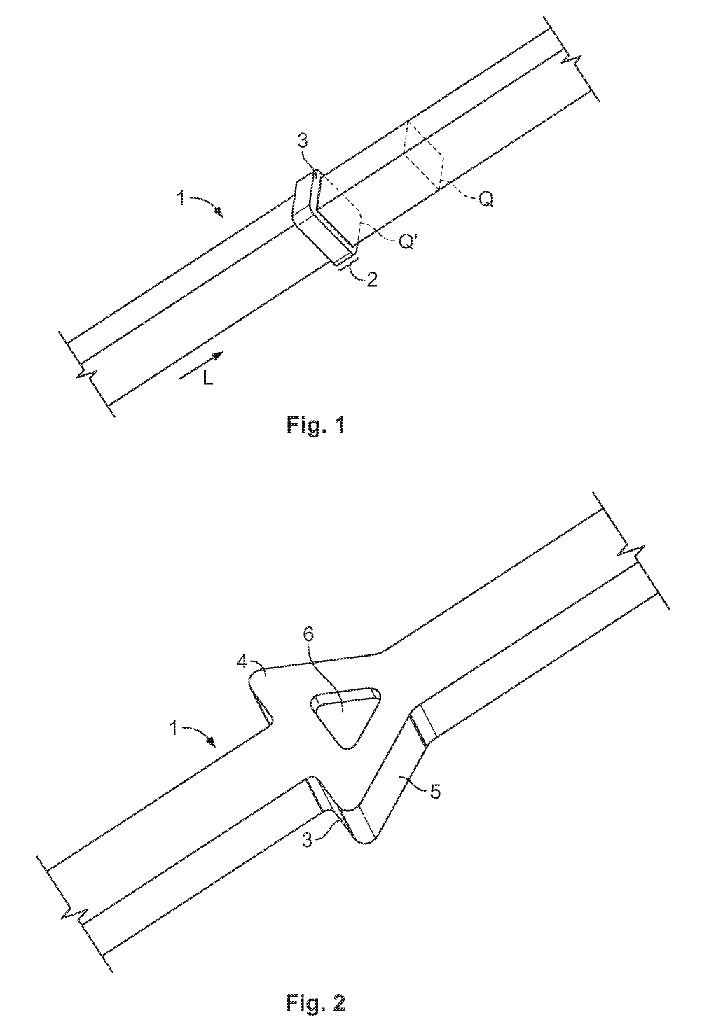

The construction of a press-fit pin configured according to the invention will firstly be described with reference to FIG. 1 which shows a perspective view of the compressed press-fit pin 1. The compressed press-fit pin 1 has at least one compressed location 2 in the longitudinal direction. In the region of the compressed location 2 the press-fit pin 1 has a cross-sectional area Q′ that is widened compared with its original cross-sectional area Q. A step forms at the transition from the cross-sectional area Q to the widened cross-sectional area Q′. The step forms a plane of which the normal runs in the longitudinal direction L of the press-fit pin 1. The step thus constitutes a shoulder element 3.

A shoulder element 3 is hereinafter taken to mean any kind of edge, corner, nose 4, projection 15, step, bend 12 or kink on which a tool can be supported to exert a force on the press-fit pin 1 in the longitudinal direction L. The spacing of shoulder element 3 to the tips 23 of the press-fit pin 1 should be large enough that the tips 23 are not damaged when the pin 1 is processed. This condition results in a middle section on the press-fit pin 1 which is suitable for attachment of the shoulder elements 3.

The position, shape and number of shoulder elements 3 can be freely selected in this middle section to attain optional manageability of the press-fit pin 1 for the respective application.

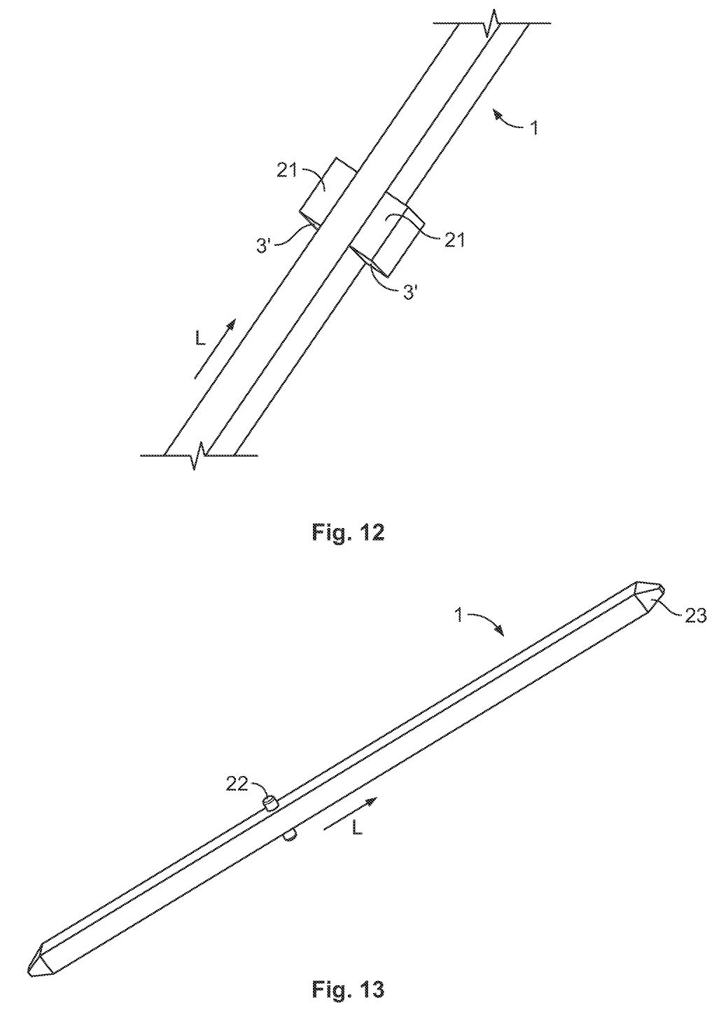

The shoulder elements 3 can improve manageability as required in that, in addition to supporting a tool, they can also be used as holding members 21 as shown in FIG. 12, a stop, a fixing, a measuring or positioning aid.

FIG. 2 shows a press-fit pin 1 constructed according to the invention comprising an impression 6 and a lateral nose 4. The underside of the nose 4 has a shoulder element 3. A bevel 5 which tapers toward the press-fit pin 1 sits on the upper side of the nose 4. The material of the press-fit pin 1 required for forming the nose 4 is pressed outwards from the center of the press-fit pin 1 by the impression 6.

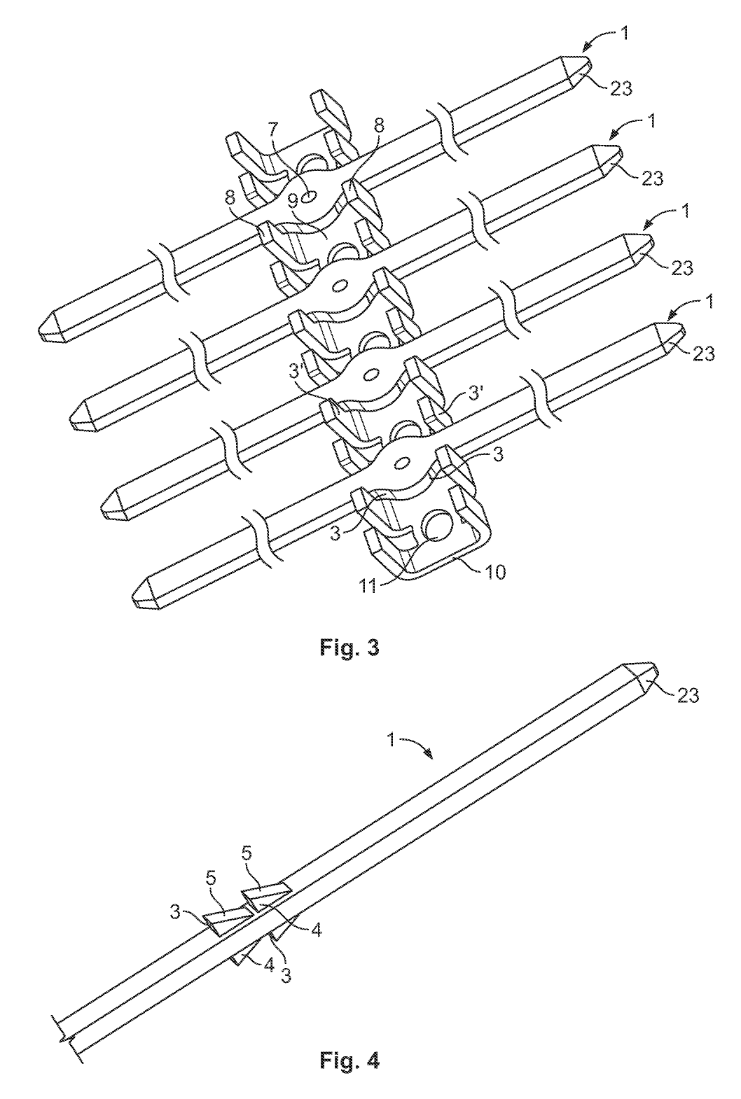

FIG. 3 shows a plurality of press-fit pins 1 provided with a gap 7 and which are framed by a carrier member 10. The gap 7 can be introduced in the center of the press-fit pin 1, in which gap 7 the pin 1 is for example inserted and widened from the inside. The external contour of the press-fit pin 1 locally increases in the region of the gap 7 and shoulder elements 3 are produced. Fingers 8 that partially surround the press-fit pin 1 are locked to the shoulder element 3 in the longitudinal direction L. The fingers 8 that at least partially surround the press-fit pin 1 are joined together by the connection 9. A plurality of fingers 8 that surround the press-fit pins 1 are joined to each other by bridges 11 and mounted side by side form a continuous carrier member 10.

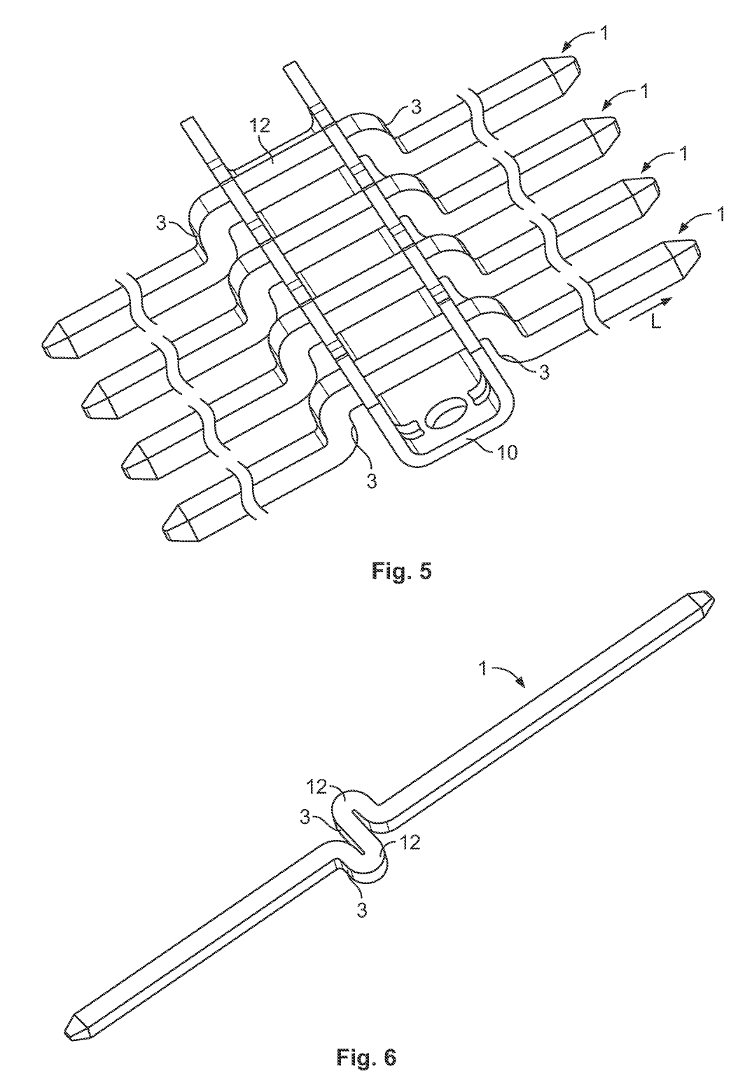

FIG. 4 shows a press-fit pin 1 constructed according to the invention and on which a plurality of noses 4 are provided. The side-by-side mounting of a plurality of noses 4 laterally on the press-fit pin 1 member the pin 1 can be pressed in a printed circuit board or female connector. The noses 4 act as barbs in this case. The bevels 5 on the noses 4 allow the noses 4 to penetrate the relevant component and the shoulder elements 3 on the noses 4 prevent the press-fit pin 1 from sliding out of the component. At the same time the shoulder elements 3 are used to secure the press-fit pin 1 in a tool which presses the press-fit pin 1 into the component.

FIG. 5 shows a plurality of press-fit pins 1 which have a bend 12 and are framed in a carrier member 10. The bend 12 produces shoulder elements 3 on the press-fit pins 1. The carrier member 10 can be supported on the shoulder elements 3. The force transmission from carrier member to press-fit pin 1 in the longitudinal direction L is improved thereby.

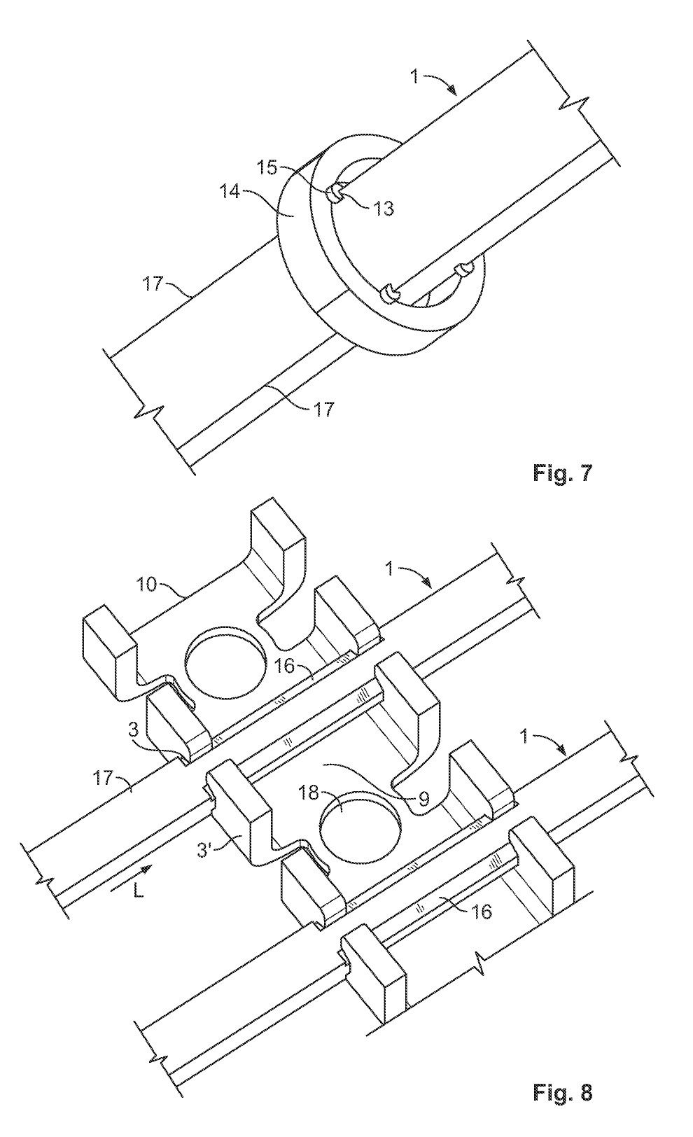

FIG. 6 shows a press-fit pin 1 which has an S-shaped bend 12 in the center. There is a plurality of shoulder elements 3 along the S-shaped bend 12. The shoulder elements 3 can be used to support a tool to press the press-fit pin 1 into a component and as a stop when pressing the press-fit pin 1 into a component.

FIG. 7 shows a press-fit pin 1 that is notched on its longitudinal edges 17 and is framed by a ring 14. On its inner side the ring 14 has projections 15 which engage in the notches 13 in the press-fit pin 1. Engagement of the projections 15 in the notches 13 results in interlocking fit between ring 14 and press-fit pin 1. The interlocking fit ensures a secure seat of the ring 14 on the press-fit pin 1. An integral connection can be achieved between the ring 14 and the press-fit pin 1 by constructing the projections 15 as welds.

FIG. 8 shows two press-fit pins 1 provided at certain sections of their longitudinal edges 17 with bevels 16 and which are framed by a carrier member 10. The framing of the press-fit pins 1 in the carrier member 10 takes place by member of the fingers 8 that surround the press-fit pins 1. The fingers 8 that surround a press-fit pin 1 have a connection 9. The surrounding fingers 8 form a unit with the connection 9.

In the step of the bevels 16 the press-fit pins 1 have shoulder elements 3. The fingers 8 that surround the press-fit pins 1 are supported on the shoulder elements 3. There is an interlocking fit between the surrounding fingers 8 and the press-fit pin 1 because of the support of the surrounding fingers 8 on the shoulder elements 3 on the press-fit pin 1.

When processing the press-fit pin 1 the surrounding fingers 8 can be used as holding members. When used as holding members they facilitate handling of the press-fit pins 1. The surrounding fingers 8 also comprise shoulder elements 3′ which promote an introduction of force in the longitudinal direction L of the press-fit pin 1.

The surrounding fingers 8 of a plurality of press-fit pins 1 can be joined together by the bridges 11. In their entirety, the surrounding fingers 8 thus produce a carrier member 10. The carrier member 10 has holes 18 between the bridges 11. The holes 18 simplify the mechanical feed of a plurality of press-fit pins 1 to a tool.

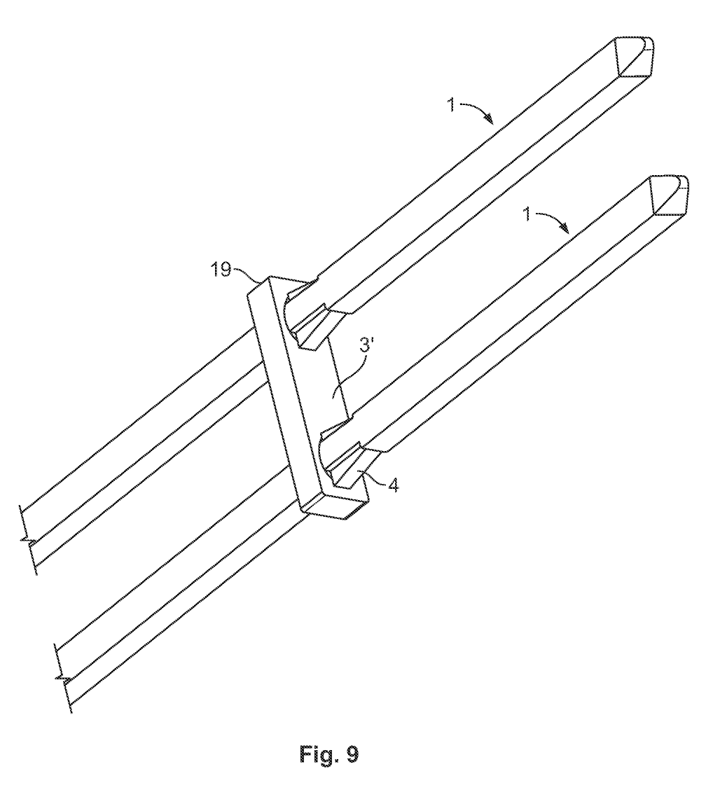

FIG. 9 shows two press-fit pins 1 which penetrate a flat body 19. The flat body 19 is supported in the longitudinal direction L on the shoulder elements 3′ of the noses 4 formed on the press-fit pins 1. The flat body 19 can also act as a carrier member and press-in shoulder and be constructed as a disc, plate or profiled body. The flat body 19 can be attached to the press-fit pin with integral, interlocking or non-positive fit and by a combination of several joining methods by being welded, pressed or adhered for example to the press-fit pin 1.

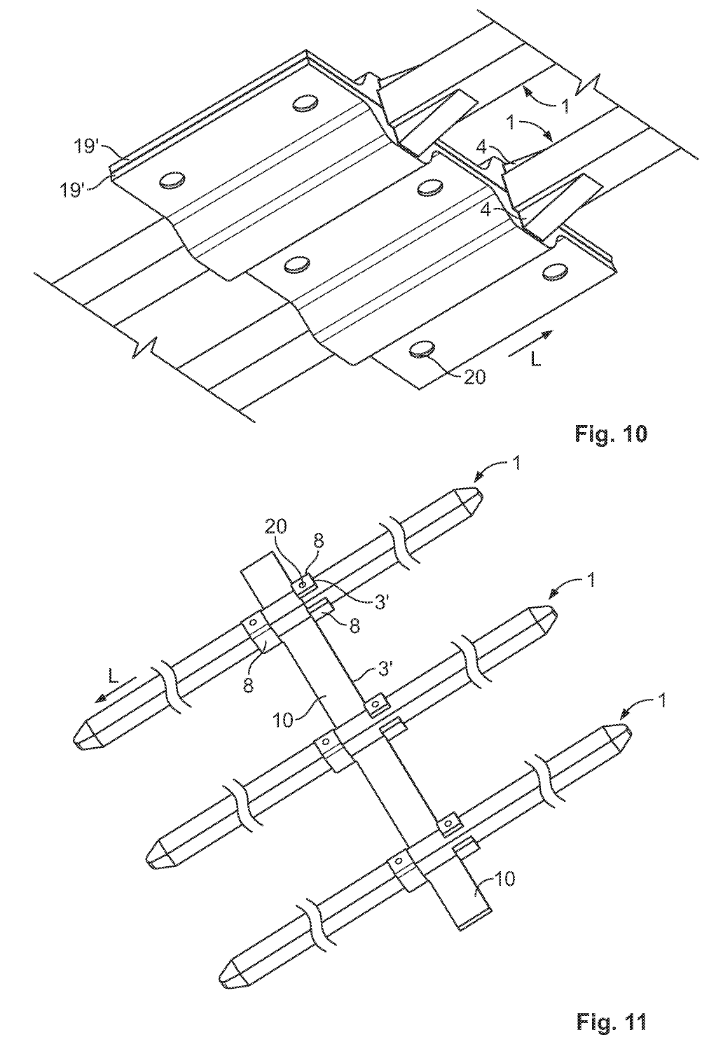

FIG. 10 shows two press-fit pins 1 which are enclosed by two flat bodies 19′. The flat bodes 19′ are joined together at the weld points 20. The flat bodies 19′ are supported on the noses 4 in the longitudinal direction L of the press-fit pins 1. The noses 4 are formed on the press-fit pins 1. The flat bodies 19′ are locked on one side in the longitudinal direction L of the press-fit pins 1 by the noses 4.

The flat bodies 19′ can be used as a holding member and carrier member and facilitate pressing of the press-fit pins 1 into a component in the longitudinal direction L. The one-sided locking member that the flat bodies 19′ can be removed from the press-fit pins 1 counter to the longitudinal direction L.

FIG. 11 shows three press-fit pins 1 to which a carrier member 10 is welded. The carrier member 10 comprises fingers 8 that surround the press-fit pins 1. The surrounding fingers 8 are integrally connected to the press-fit pins 1 at the weld points 20.

The surrounding fingers 8 and the shoulder elements 3′ on the carrier member 10 can be used by a tool for introducing a force in the longitudinal direction L or satisfy the purpose of a holding member.

The carrier member 10 is used to feed a plurality of press-fit pins 1 into a processing machine. The carrier member 10 can be removed before, during or after processing of the press-fit pins 1.

FIG. 12 shows a press-fit pin 1 with welded-on holding member 21. The holding member 21 comprise shoulder elements 3′. By way of the shoulder elements 3′ the holding member 21 may be used as press-in shoulders for pressing the press-fit pin 1 into a component. Since the holding member 21 comprise shoulder elements 3′ on both sides, they can be used for introducing a force in the longitudinal direction L of the press-fit pin 1 and as a stop.

FIG. 13 shows a press-fit pin 1 which is shot through by a pin 22. Since the pin 22 is longer than the press-fit pin 1 is wide, the pin 22 can be used as a press-in shoulder. The pin 22 is used to transmit a force to the press-fit pin 1 in the longitudinal direction L thereof or to secure the pin.

Pressing a press-fit pin 1 into a component is also facilitated if it comprises tips 23 at its ends.

Deviations from the above-described embodiments are possible within the inventive idea. Thus shoulder elements 3 or 3′, noses 4, impressions 6, gaps 7, bends 12, notches 13, projections 15 and bevels 16 used as assembly aids can be provided on the press-fit pin 1 where assembly of the pin requires. A pin 1 can therefore be pressed deeper into a component the closer such an assembly aid is located to an end of the pin 1. If an assembly aid is positioned centrally on the pin 1 in such a way that pin and assembly aid are symmetrical, the pin can be pressed into a component with any end. The positions of the surrounding fingers 8, carrier strips 10, flat bodies 19 or 19′, holding member 21 and pins 22 can also be varied as desired.

To provide press-fit pin material for forming shoulder elements 3 and noses 4 the press-fit pin 1 can be compressed or impressed as desired.

All noses 4, impressions 6, gaps 7, surrounding fingers 8, carrier strips 10, bends 12, notches 13, rings 14, projections 15, bevels 16, flat bodies 19, holding member 21 and pins 22 comprising shoulder elements 3 or 3′ can be used as press-in shoulders and serve as holding members.

The shoulder elements 3 or 3′ can also be used as stops when processing the press-fit pin 1.

Surrounding fingers 8, carrier strips 10, flat bodies 19 and pins 22 can be removed or remain in place following processing of the press-fit pin 1.

What is claimed is:

1. A press-fit pin made from wire material for electrical contacts, comprising at least one shoulder element.

2. The press-fit pin according to claim 1, wherein the at least one shoulder element is formed in one piece from the material of the press-fit pin.

3. The press-fit pin according to claim 2, wherein the press-fit pin comprises a cross-sectional widening in the region of the at least one shoulder element.

4. The press-fit pin according to claim 2 wherein the press-fit pin is impressed in the region of the at least one shoulder element.

5. The press-fit pin according to claim 2 wherein the press-fit pin is split in the region of the at least one shoulder element.

6. The press-fit pin according to claim 2 wherein at least one laterally protruding nose forms the at least one shoulder element.

7. The press-fit pin according to claim 2 wherein the press-fit pin comprises a bend in the region of the at least one shoulder element.

8. The press-fit pin according to claim 8, wherein the bend is S-shaped.

9. The press-fit pin according to claim 2 wherein the press-fit pin, at least in certain sections, comprises at least one notch extending transversely to the longitudinal direction of the press-fit pin.

10. The press-fit pin according to claim 6, wherein the press-fit pin has at least one longitudinal edge and the at least one longitudinal edge, at least in certain sections, comprises a bevel.

11. The press-fit pin according to claim 2, wherein the press-fit pin comprises a holding member.

12. The press-fit pin according to claim 11 wherein the press-fit pin and the holding member are in two pieces.

13. The press-fit pin according to claim 12 wherein the holding member is a finger that at least partially surrounds the press-fit pin.

14. The press-fit pin according to claim 14, wherein the finger that at least partially surrounds the press-fit pin is annular.

15. The press-fit pin according to claim 14, characterized in that the finger that at least partially surrounds the press-fit pin is a flat body penetrated by the press-fit pin.

16. The press-fit pin according to claim 13 wherein a plurality of fingers that at least partially surround the press-fit pin are joined together.

17. The press-fit pin according to claim 12 wherein two flat bodies that surround the press-fit pin and are joined together form the holding member.

18. The press-fit pin according to claim 12 wherein fingers that at least partially surround the press-fit pin or two flat bodies that surround the press-fit pin form a carrier member.

19. The press-fit pin according to claim 12 wherein the holding member is welded to the press-fit pin.

20. The press-fit pin according to claim 12 wherein the holding member is a pin that penetrates the press-fit pin transversely to its longitudinal direction.

21. The press-fit pin according to claim 12 wherein the holding member is supported on the at least one shoulder element by at least one notch running, at least in certain sections, transversely to the longitudinal direction of the press-fit pin, and having a bevel.

22. The press-fit pin according to claim 11 wherein the holding member comprises a shoulder element.
